(19) United States
(12) Patent Application Publication
(10) Pub. No.: US 2026/0194235 A1
(43) Pub. Date: Jul. 9, 2026

(54) BATTERY-ASSISTED COOKING SYSTEM IN AN OVEN RANGE APPLIANCE

(71) Applicant: Haier US Appliance Solutions, Inc., Wilmington, DE (US)

(72) Inventor: Eric Scott Johnson, Louisville, KY (US)

(21) Appl. No.: 19/014,318

(22) Filed: Jan. 9, 2025

(51) Int. Cl. F24C 15/00; F24C 7/06; H01M 10/627

(52) U.S. Cl. CPC F24C 15/006; F24C 7/067; F24C 15/007; H01M 10/627

(57) ABSTRACT

A battery assembly for a cooking appliance includes a battery housing defining a battery compartment and a front opening for accessing the battery compartment, a battery mounted within the battery compartment and being electrically coupled to an electric heating element of the cooking appliance, an access panel removably positioned over the front opening for providing selective access to the battery compartment, and one or more airflow apertures defined in the access panel or along a portion of a perimeter of the access panel through which a flow of cooling air may flow into the battery compartment.

### FIELD OF THE INVENTION

The present subject matter relates generally to cooking appliances, and more particularly, to an oven range appliance that includes a battery-assisted cooking system.

### BACKGROUND OF THE INVENTION

Conventional residential and commercial cooking appliances generally include a cabinet that includes a cooking chamber (e.g., an oven chamber) for receipt of food items for cooking. Multiple heating elements are positioned within the cooking chamber to provide heat to food items located therein. The heating elements can include, for example, radiant heating elements, such as a bake heating assembly positioned at a bottom of the cooking chamber and/or a separate broiler heating assembly positioned at a top of the cooking chamber. In addition, cooking appliances commonly include a cooktop positioned on top of the oven chamber and having a plurality of gas burners or electric heating elements for heating pots, pans, etc. These cooking appliances are often called “oven range appliances,” “oven ranges,” or simply “ranges.”

Notably, conventional cooking appliances that include electric heating elements in the oven chamber and electric heating elements on the cooktop that are powered by a main electricity supply. However, a user's kitchen may be wired for a first voltage (e.g., 120 VAC for a gas range), requiring rewiring by an electrician to use a conventional electric oven, cooktop, and/or range that operates at a second voltage (e.g., 240 VAC). Accordingly, purchasers of electric oven ranges may be disappointed when their product cannot be used when installed or when they need to hire an electrician to rewire prior to operation, resulting in user dissatisfaction. In addition, conventional cooking appliances are operated entirely from mains electricity, thus providing no ability to reduce peak loads on the electrical grid, shift energy use to off-peak times, etc.

Accordingly, an electric cooking appliance that may operate using an energy source other than mains electricity would be desirable. More specifically, a cooking appliance that is versatile and operates to reduce peak load on the electrical grid, shift energy use to off-peak times, and operate more efficiently would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a cooking appliance defining a vertical direction, a lateral direction, and a transverse direction is provided. The cooking appliance includes a cabinet, a cooking chamber positioned within the cabinet, an electric heating element positioned in thermal communication with the cooking chamber, a battery housing positioned within the cabinet adjacent to the cooking chamber, the battery housing defining a battery compartment and a front opening for accessing the battery compartment, a battery mounted within the battery compartment and being electrically coupled to the electric heating element, an access panel removably positioned over the front opening for providing selective access to the battery compartment, and one or more airflow apertures defined in the access panel or along a portion of a perimeter of the access panel through which a flow of cooling air may flow into the battery compartment.

In another exemplary embodiment, a battery assembly for a cooking appliance is provided, the cooking appliance comprising an electric heating element. The battery assembly includes a battery housing defining a battery compartment and a front opening for accessing the battery compartment, a battery mounted within the battery compartment and being electrically coupled to the electric heating element, an access panel removably positioned over the front opening for providing selective access to the battery compartment, and one or more airflow apertures defined in the access panel or along a portion of a perimeter of the access panel through which a flow of cooling air may flow into the battery compartment.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a cooking appliance according to an example embodiment of the present subject matter.

FIG. 2 provides a front perspective view of the example cooking appliance of FIG. 1 with a door in the open position according to an example embodiment of the present subject matter.

FIG. 3 provides a side, schematic view of the example cooking appliance of FIG. 1 according to an example embodiment of the present subject matter.

FIG. 4 provides a partial perspective view of a battery assembly of the example cooking appliance of FIG. 1 according to an example embodiment of the present subject matter.

FIG. 5 provides a partial perspective view of the example battery assembly of FIG. 4 according to an example embodiment of the present subject matter.

FIG. 6 provides a side, cross-sectional view of the example battery assembly of FIG. 4 according to an example embodiment of the present subject matter.

FIG. 7 provides a perspective view of the example battery assembly of FIG. 4 with a trim panel removed for clarity according to an example embodiment of the present subject matter.

FIG. 8 provides a schematic view of an air intake portion of the example battery assembly of FIG. 4 according to an example embodiment of the present subject matter.

FIG. 9 provides a schematic view of an air intake portion of the example battery assembly of FIG. 4 according to an example embodiment of the present subject matter.

FIG. 10 provides a schematic view of an air intake portion of the example battery assembly of FIG. 4 according to an example embodiment of the present subject matter.

FIG. 11 provides a partial perspective view of the example battery assembly of FIG. 4 with certain components removed for clarity according to an example embodiment of the present subject matter.

FIG. 12 provides a perspective view of the example battery assembly of FIG. 4 with certain components removed for clarity according to an example embodiment of the present subject matter.

FIG. 13 provides a schematic view of a battery support structure of the example battery assembly of FIG. 4 according to an example embodiment of the present subject matter.

FIG. 14 provides a perspective view of a battery of the example battery assembly of FIG. 4 according to an example embodiment of the present subject matter.

FIG. 15 provides a schematic view of the example battery assembly of FIG. 4 according to an example embodiment of the present subject matter.

FIG. 16 provides a side, cross-sectional view of the example cooking appliance of FIG. 1 according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As explained herein, aspects of the present subject matter are generally directed to an innovative cooking appliance design incorporating a removable battery to power its heaters. Notably, batteries with sufficient energy to power a cooking appliance are heavy and may impose limitations on how a product containing them may be shipped. Batteries with sufficient energy to power a cooking appliance also generate significant internal heat, which must be removed to maintain the battery below its temperature limit. Accordingly, aspects of the present subject matter describe a product structure to enable use of a battery. The battery may be removable from the product, enabling the battery to be shipped separately from the product and be installed before use. A replaceable battery also simplifies installation and service.

According to example embodiments, the cooking appliance structure may include a battery compartment positioned adjacent to the cooking chamber of the cooking appliance, e.g., positioned below the cooking chamber. This battery compartment may include a front-facing opening facilitating battery installation and removal, covered by a detachable access panel to restrict user access, potentially secured with fasteners. This access panel might integrate airflow apertures for enhanced thermal management. Optionally, a trim panel, which may be adaptable or removable, may enhance the aesthetics of the cooking appliance and allow interaction with the access panel, potentially employing hinges, brackets, or shoulder screws for support. The access panel may incorporate a power outlet that draws from the cooking appliance's battery, allowing users to power external devices (e.g., 120 VAC devices). This power outlet, which may be part of the battery, may remain accessible through an opening in the access panel when installed and covered.

In addition, the battery may be supported within the battery compartment in various ways. For example, the battery may be supported by a shelf inside the battery compartment. This shelf can be rigidly fixed and supported from various directions (bottom, sides, top) by parts of the cooking appliance's structure, such as the range back, the front frame, base rails, etc. The battery can be installed by sliding it through the front opening of the compartment onto the shelf. Alternatively, the shelf may be movable, supported by low-friction sliding surfaces like ball-bearing slides or plastic guides attached to the cooking appliance's structure. This movable shelf may allow the battery to be easily placed by sliding it forward through the opening.

According to another example embodiment, the battery may be supported by a rail system inside the compartment. This rail system can be incorporated into the battery itself (e.g., along its sides, top, or bottom faces) or attached to the cooking appliance's structure. The rails may engage with channels attached to the structure or incorporated into the battery. These rail and channel profiles may be designed to ensure proper alignment during assembly and provide vertical support if the rail system is positioned above or below the battery. Installation may involve sliding the battery through the front opening and engaging the rails with the channels.

Electrical connections to the battery may also be positioned and configured in any suitable manner. For example, these electrical connections may be located near the front of the battery, either along its front face or within the forward regions, typically at the front 25%, of its top, side, or back. This setup simplifies both installation and servicing, ensuring that when the battery is installed, both the battery-side and product-side connectors are easily accessible. These wires from the product side may be routed either from the back of the cooking appliance, around the range back or through an opening in it, or from the side, such as down the gap between the side panel and oven insulation, into the battery compartment.

In addition, aspects of the present subject matter may be directed to a thermal management system and strategies in focusing on enhancing the cooling of a battery compartment of a cooking appliance including a battery for powering one or more heaters. For example, air may be directed into the battery compartment primarily through its front face, which may involve air passing through gaps between the oven door and a trim panel, if present, or directly through openings in the access panel when no trim panel is used. Additional openings for air intake can be found in various parts of the trim panel such as its bottom, sides, top, or front. In setups that utilize buoyant airflow for cooling, air may also enter through the lower sides of the battery compartment, flowing in from spaces between the cooking appliance's front frame and the floor or side panels. The design may include mechanisms like a gasket or a diverter to manage the flow of air, ensuring that it is adequately directed into the battery compartment while maintaining necessary airflow to other parts of the appliance, such as the bottom of the oven door, to optimize overall thermal management.

For the cooling strategy involving buoyant airflow, air heated by the battery within the compartment can escape through the top portions of the battery compartment's sides or its back, potentially via an aligned opening in the range back. For example, once air is expelled from the sides of the battery compartment, the air enters the gap between the oven's insulation and the side panels. It then moves upward, propelled by buoyancy or aided by a cooling fan, into the space between the oven insulation and the cooktop, eventually exiting through a vent trim located near the top back of the cooking appliance. If the exhaust is via the range back, the hot air may travel into the space between the range back and the enclosure's back wall, exiting through an upper rear vent trim. In this regard, the enclosure may refer to the surfaces adjacent to one or more sides of cooking appliance 100 (e.g., the floor, back wall, side walls, etc.). The structural design of the battery compartment may vary, e.g., its sides may be unobstructed with the battery supported by a shelf anchored to the base rail structure, or it might have partially enclosed sides with openings at the top if the battery support involves ball-bearing slides attached to brackets that span a portion of the gap between the base rails and the lower insulation retainer.

According to an example embodiment, the cooling strategy utilizing a fan within the battery compartment of a range employs air heated by the battery, which is then expelled through various openings (sides, back, bottom, and/or top) due to fan-generated suction and exhaust pressures. The battery compartment, which is substantially enclosed apart from the front access panel, comprises side panels, a bottom panel, a top panel, and a back panel, which may be shared with the cooking appliance's structural components. Fans, which could be axial, radial, or tangential, may be positioned such that their intake communicates with the interior of the compartment and their exhaust with the exterior. In the primary embodiment where the air is exhausted through the back face, the air may flow out of the product via spaces between structural components, such as between the range back and enclosure back wall or between the battery compartment bottom and the enclosure bottom, ultimately exiting through various openings like vent trims. Radial fans can be mounted with their axis of rotation either left-to-right or vertically, with the exhaust connected to an opening in the back face of the compartment. Axial fans may have their axis front-to-back, and tangential fans can be oriented left-to-right or top-to-bottom, facilitating flexible integration depending on the fan's intake or exhaust configuration. Additionally, a flexible flap can be employed to regulate airflow from the bottom back edge of the battery compartment to the enclosure floor.

In addition, the thermal management system may include one or more heat shields with faces having different emissivity. For example, a heat shield may also be provided below the oven's bottom insulation retainer with an air gap and may be designed to minimize heat transfer to the battery compartment by utilizing surfaces with differing emissivity. The top face of the shield, which faces the oven, features a low emissivity (e.g., 0.20) to reflect radiant heat from the oven, while its bottom face, directed towards the battery, has a high emissivity (e.g., 0.90) to absorb and dissipate heat from the battery, acting as a heat sink. This dual-emissivity setup can be achieved through coatings on a single material or by using multiple materials such as aluminum foil on the top and painted steel on the bottom. The heat shield may be constructed from materials like carbon steel (e.g., specifications 24×18×0.030 inches), chosen for their specific heat, density, and thermal conductivity to ensure only minor temperature increases when absorbing radiant heat from the battery during cooking. Additionally, the shield's efficiency in cooling may be bolstered by airflow through the battery compartment.

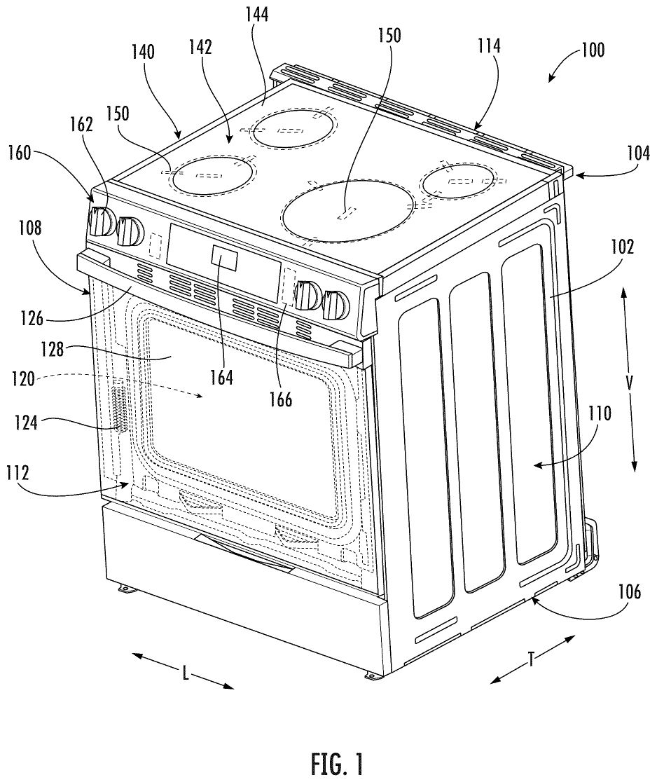

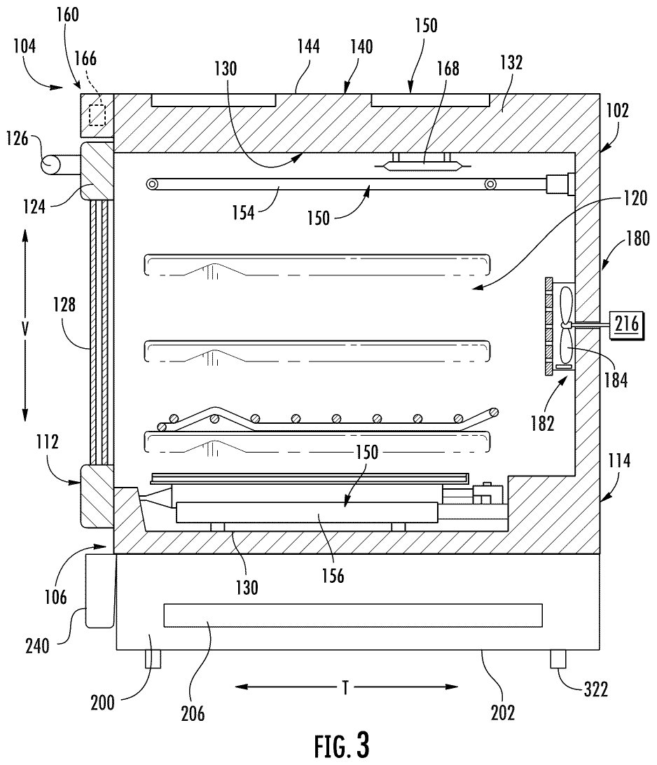

FIG. 1 provides a front, perspective view of a cooking appliance 100 as may be employed with the present subject matter. Cooking appliance 100 generally defines a vertical direction V, a lateral direction L, and a transverse direction T, each of which is mutually perpendicular, such that an orthogonal coordinate system is generally defined. As illustrated, cooking appliance 100 includes an insulated cabinet 102. Cabinet 102 of cooking appliance 100 extends between a top 104 and a bottom 106 along the vertical direction V, between a first side 108 (left side when viewed from front) and a second side 110 (right side when viewed from front) along the lateral direction L, and between a front 112 and a rear 114 (FIG. 3) along the transverse direction T.

Within cabinet 102 is a single cooking chamber 120 which is configured for the receipt of one or more food items to be cooked. However, it should be appreciated that cooking appliance 100 is provided by way of example only, and aspects of the present subject matter may be used in any suitable cooking appliance, such as a double oven range appliance. Thus, the example embodiment shown in FIG. 1 is not intended to limit the present subject matter to any particular cooking chamber configuration or arrangement. Indeed, aspects of the present subject matter may be applied to any suitable cooktop appliance.

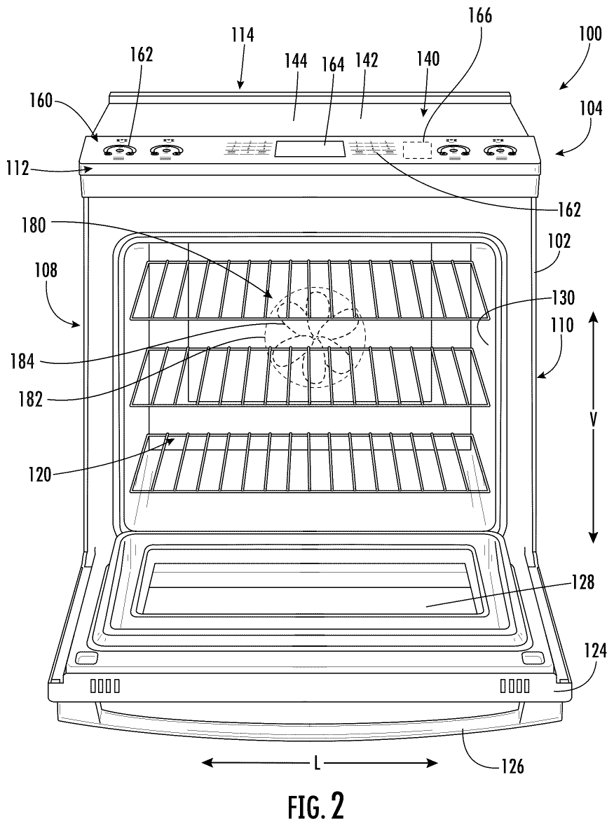

Referring now also to FIGS. 2 and 3, cooking appliance 100 includes a door 124 rotatably attached to cabinet 102 in order to permit selective access to cooking chamber 120. Handle 126 is mounted to door 124 to assist a user with opening and closing door 124 in order to access cooking chamber 120. As an example, a user can pull on handle 126 mounted to door 124 to open or close door 124 and access cooking chamber 120. One or more transparent viewing windows 128 (FIG. 1) may be defined within door 124 to provide for viewing the contents of cooking chamber 120 when door 124 is closed and also assist with insulating cooking chamber 120.

Cooking chamber 120 is defined by a plurality of chamber walls 130. Specifically, cooking chamber 120 may be defined by a top wall, a rear wall, a bottom wall, and two sidewalls 130. These chamber walls 130 may be joined together to define an opening through which a user may selectively access cooking chamber 120 by opening door 124. In order to insulate cooking chamber 120, cooking appliance 100 includes an insulating gap defined between the chamber walls 130 and cabinet 102. According to an exemplary embodiment, the insulation gap is at least partially filled with an insulating material 132, such as insulating foam or fiberglass, for insulating cooking chamber 120.

Cooking appliance 100 also includes a cooktop 140. Cooktop 140 is positioned at or adjacent top 104 of cabinet 102 such that it is positioned above cooking chamber 120. Specifically, cooktop 140 includes a top panel 142 positioned proximate top 104 of cabinet 102. By way of example, top panel 142 may be constructed of glass, ceramics, enameled steel, and combinations thereof. For example, according to the illustrated embodiment, cooktop includes a ceramic glass panel 144 having a plurality of cooking zones.

Cooking appliance 100 may further include one or more heating elements (identified generally by reference numeral 150) for selectively heating cooking utensils positioned on glass panel 144 or food items positioned within cooking chamber 120. For example, referring to FIG. 1, heating elements 150 may be electric burners 150. Specifically, a plurality of electric burners 150 are mounted within or on top of top panel 142 underneath a glass panel 144 that supports cooking utensils over the electric burners 150 while electric burners 150 provide thermal energy to cooking utensils positioned thereon, e.g., to heat food and/or cooking liquids (e.g., oil, water, etc.). Electric burners 150 can be configured in various sizes so as to provide e.g., for the receipt of cooking utensils (i.e., pots, pans, etc.) of various sizes and configurations and to provide different heat inputs for such cooking utensils. According to alternative embodiments, cooking appliance 100 may have other cooktop configurations or burner elements.

In addition, heating elements 150 may be positioned within or may otherwise be in thermal communication with cooking chamber 120 for regulating the temperature within cooking chamber 120. Specifically, an upper heating element 154 (also referred to as a broil heating element) may be positioned in cabinet 102, e.g., at a top portion of cooking chamber 120, and a lower heating element 156 (also referred to as a bake heating element) may be positioned at a bottom portion of cooking chamber 120. Upper heating element 154 and lower heating element 156 may be used independently or simultaneously to heat cooking chamber 120, perform a baking or broil operation, perform a cleaning cycle, etc. The size and heat output of heating elements 154, 156 can be selected based on the, e.g., the size of cooking appliance 100 or the desired heat output. Cooking appliance 100 may include any other suitable number, type, and configuration of heating elements 150 within cabinet 102 and/or on cooktop 140. For example, cooking appliance 100 may further include gas burners, electric heating elements, induction heating elements, or any other suitable heat generating device.

Although aspects of the present subject matter are described herein in the context of a single oven cooking appliance, it should be appreciated that cooking appliance 100 is provided by way of example only. Other oven or range appliances having different configurations, different appearances, and/or different features may also be utilized with the present subject matter, e.g., double ovens, standalone cooktops, etc.

As illustrated, cooking appliance 100 may generally include a user interface panel 160 that is located within convenient reach of a user of the cooking appliance 100. For example, according to the illustrated embodiment, user interface panel 160 is mounted at a front 112 and top 104 corner of cabinet 102, e.g., directly above door 124. Although user interface panel 160 is illustrated as being mounted at a top, front of cabinet 102, it should be appreciated that aspects of the present subject matter may be applicable to other mounting locations of control panels, e.g., such as front mount control panels, rear mount panels, etc. In addition, it should be appreciated that the present subject matter is not limited oven applications but could instead be applied to any other suitable appliance.

For this example embodiment, user interface panel 160 includes control inputs 162 that are each associated with one of heating elements 150. In this manner, control inputs 162 allow the user to activate each heating element 150 and determine the amount of heat input provided by each heating element 150 to a cooking food items within cooking chamber 120 or on cooktop 140. Although control inputs 162 are illustrated as touch-sensitive or contact inputs, it should be understood that control inputs 162 and the configuration of cooking appliance 100 shown in FIG. 1 is provided by way of example only. More specifically, user interface panel 160 may include various input components, such as one or more of a variety control knobs, electrical, mechanical or electro-mechanical input devices including rotary dials, push buttons, and touch pads. User interface panel 160 may also be provided with one or more graphical display devices or display components 164, such as a digital or analog display device designed to provide operational feedback or other information to the user such as e.g., whether a particular heating element 150 is activated and/or the rate at which the heating element 150 is set.

User interface panel 160 may be in direct operative communication with a controller 166 of cooking appliance 100, such that user inputs via user interface panel 160 may be directly used to regulate operation of various components of cooking appliance 100. User interface panel 160 of cooking appliance 100 may be in communication with controller 166 via, for example, one or more signal lines or shared communication busses, and signals generated in controller 166 operate cooking appliance 100 in response to user input via user input devices 162. Input/Output (“I/O”) signals may be routed between controller 166 and various operational components of cooking appliance 100 such that operation of cooking appliance 100 can be regulated by controller 166.

Controller 166 is a “processing device” or “controller” and may be embodied as described herein. Controller 166 may include a memory and one or more microprocessors, microcontrollers, application-specific integrated circuits (ASICS), CPUs or the like, such as general or special purpose microprocessors operable to execute programming instructions or micro-control code associated with operation of cooking appliance 100, and controller 166 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

In addition, controller 166 may also be communication with one or more sensors, such as temperature sensor 168 (FIG. 3), which may be used to measure temperature inside cooking chamber 120 and provide such measurements to the controller 166. As used herein, “temperature sensor” or the equivalent is intended to refer to any suitable type of temperature measuring system or device positioned at any suitable location for measuring the desired temperature. Thus, for example, temperature sensor 168 may each be any suitable type of temperature sensor, such as a thermistor, a thermocouple, a resistance temperature detector, a semiconductor-based integrated circuit temperature sensor, etc. In addition, temperature sensor 168 may be positioned at any suitable location and may output a signal, such as a voltage, to a controller that is proportional to and/or indicative of the temperature being measured. Although exemplary positioning of temperature sensors is described herein, it should be appreciated that cooking appliance 100 may include any other suitable number, type, and position of temperature and/or other sensors according to alternative embodiments.

In some embodiments, cooking appliance 100 includes a convection heating assembly 180 that operates in conjunction with cooking chamber heaters (e.g., upper heating element 154 and lower heating element 156) to facilitate convection cooking within cooking chamber 120. In this regard, convection heating assembly 180 may operate to circulate a flow of heated air within cooking chamber 120 to facilitate more even heating and shorter cooking cycle times. Although an example convection heating assembly 180 is described below, it should be appreciated that variations and modifications may be made while remaining within the scope of the present subject matter.

As best shown in FIG. 3, convection heating assembly 180 includes a convection fan enclosure 182 positioned proximate a rear of cooking chamber 120. In this regard, convection fan enclosure 182 is defined at least partially by a front wall and a rear wall spaced apart along the transverse direction T. The front wall may define one or more apertures that permit the flow of heated air to pass into and out of convection fan enclosure 182. According to alternative example embodiments, convection fan enclosure 182 may include alternative airflow paths, ducts, or other flow regulating devices for directing the flow of heated air within convection fan enclosure 182 and throughout cooking chamber 120.

As illustrated, convection heating assembly 180 further includes a convection fan 184 mounted in cabinet 102 (e.g., within convection fan enclosure 182) for circulating the flow of heated air in cooking chamber 120. Specifically, convection fan 184 is illustrated as a centrifugal fan, though other suitable fan types and configurations are possible and within the scope of the present subject matter. A drive motor 186 may be mounted to cabinet 102 and may be mechanically coupled to convection fan 184 for selectively rotating convection fan 184. Controller 166 may be in operative communication with drive motor 186 for selectively rotating convection fan 184 at desired times within a cooking cycle.

Referring now generally to FIGS. 1 through 16, a battery assembly 200 that may be used with cooking appliance 100 will be described according to an example embodiment of the present subject matter. As explained herein, battery assembly 200 may be used to support operation of one or more heating elements of cooking appliance 100 (e.g., such as heating elements 150, 154, and/or 156). However, it should be appreciated that aspects of the present subject matter are not limited to use of battery assembly 200 with cooking appliance 100. Indeed, aspects of the present subject matter may be applicable to other cooking appliances having any other suitable configurations, such as ranges, stand-alone ovens, stand-alone cooktops, etc.

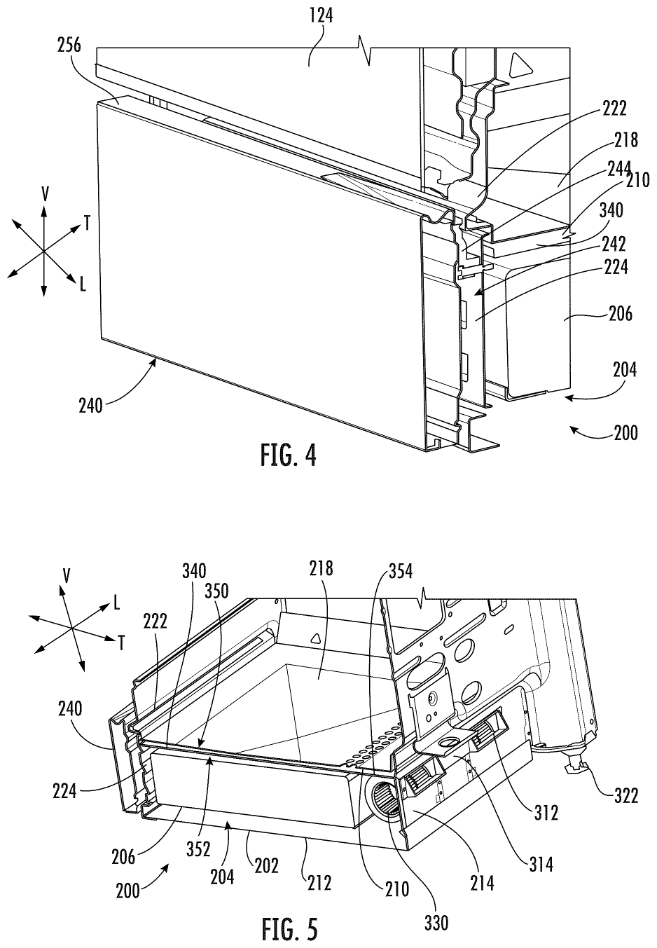

According to an example embodiment, battery assembly 200 may generally include a battery housing 202 that generally defines a battery compartment 204 for receiving a battery 206. For example, as best illustrated in FIGS. 4 through 7, battery housing 202 may include a top panel 210 and a bottom panel 212 spaced apart along the vertical direction V, a rear panel 214 positioned proximate a rear 114 of cabinet 102, and two side panels 216 spaced apart along the lateral direction L. These panels 210-216 may be part of cabinet 102, may be part of chamber walls 130, or may be one or more separate walls that are joined together to define battery compartment 204, e.g., the enclosure configured to receive and support battery 206. Variations and modifications to the construction of battery housing 202 are possible and within the scope of the present subject matter.

According to the illustrated embodiment, battery housing 202 is positioned within cabinet 102 adjacent to cooking chamber 120. More specifically, battery housing 202 is illustrated as being positioned below cooking chamber 120. In addition, it should be appreciated that insulating material 132 may be positioned between cooking chamber 120 and battery housing 202 to act as a thermal break or insulator to prevent heat transfer from cooking chamber 120 into battery compartment 204. More specifically, according to the illustrated embodiment, cooking appliance 100 includes an insulation retainer 218 that is supported in a substantially horizontal plane below a bottom chamber wall 130 of cooking chamber 120 to keep insulating material 132 in place. It should be appreciated that insulation retainer 218 may be fixed within cabinet 102 in any suitable manner, e.g., by being suspended from cooking chamber 120, by mounting directly to the structure of cabinet 102, etc. According to an example embodiment, insulation retainer 218 may form top panel 210 of battery housing 202, though alternative covers and enclosure panels are possible and within the scope of the present subject matter.

As illustrated, battery housing 202 may generally define a front opening 220 through which battery 206 may be installed, connected, serviced, etc. For example, front opening 220 may be defined by a front frame member 222, e.g., where top panel 210, bottom panel 212, and side panels 216 are seated or joined to form a substantially sealed battery compartment 204. Notably, it may be desirable to prevent access to battery 206 after it has been charged or is otherwise connected and is being used in cooking appliance 100. Accordingly, battery assembly 200 may further include an access panel 224 that is positioned over front opening 220 and is intended to prevent undesirable access into battery compartment 204. In general, access panel 224 may be formed from any suitably rigid material, such as sheet metal, injection-molded or thermoformed plastic, etc.

As illustrated, access panel 224 may be secured to cabinet 102 or front frame member 222 using one or more mechanical fasteners 226. For example, four mechanical fasteners 226 may be used to secure access panel 224, thereby preventing unauthorized or unintended access into battery compartment 204. However, it should be appreciated that access panel 224 may alternatively be installed or secured in any other suitable manner, e.g., using a mechanical hinge, one or more clips, hooks, or other suitable mechanical attachment features that may be removed to facilitate access to battery compartment 204 and service of battery 206.

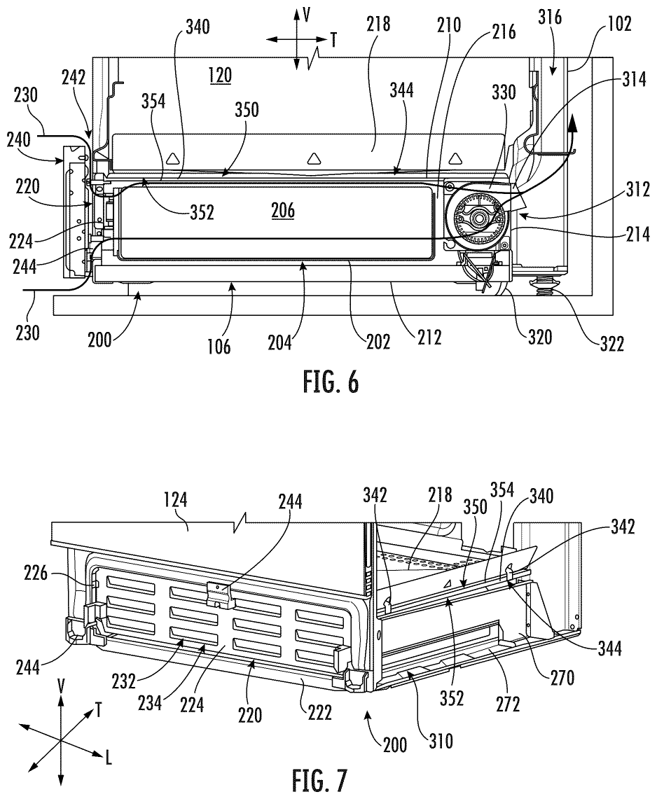

Notably, it may be desirable to facilitate the introduction of a flow of cooling air (e.g., identified in FIGS. 6, 8 through 10, and 16 by reference numeral 230) into battery compartment 204 to cool battery 206 or otherwise dissipate heat generated during charging or discharging of the battery, to evacuate heat leakage from cooking chamber 120, etc. Accordingly, access panel 224 may define one or more airflow apertures 232 through which the flow of cooling air 230 may flow into battery compartment 204. These airflow apertures 232 may generally define an air intake 234 to facilitate cooling of battery compartment 204 through buoyant or forced cooling, as will be described in more detail below. It should be appreciated that air intake 234 may be defined at other locations within cabinet 102 or battery housing 202 according to alternative embodiments, non-limiting examples of which will be described in more detail below.

According to an example embodiment, cooking appliance 100 or battery assembly 200 may further include a trim panel 240 that is attached to a front of access panel 224. For example, trim panel 240 may be an appearance piece intended to limit visibility of access panel 224 and improve the aesthetics of cooking appliance. For example, trim panel 240 may be formed from any suitably rigid material such as stamped and formed sheet metal. As illustrated, trim panel 240 may sit flush with a front surface of door 124 and may be spaced apart from access panel 224 along the transverse direction T, e.g., thereby defining an inlet gap 242 between trim panel 240 and access panel 224 through which the flow of cooling air 230 may flow into battery compartment 204. For example, the flow of cooling air 230 may flow into inlet gap 242 around a top, bottom, or sides of trim panel 240, where it may then flow through airflow apertures 232 and into battery compartment 204.

According to example embodiments, trim panel 240 may be attached to cabinet 102, front frame member 222, access panel 224, or battery housing 202 in any suitable manner. For example, trim panel 240 may be attached to access panel 224 using one or more mechanical fasteners, a hinge, brackets, or any other suitable structure. Specifically, according to the illustrated embodiment shown in FIGS. 4, 6, and 7, cooking appliance 100 may include one or more trim panel support brackets 244 attached to a front of battery housing 202, access panel 224, or cabinet 102 for receiving trim panel 240. According to an example embodiment, a top trim panel support bracket 244 may support a middle of trim panel 240 and two side trim panel support brackets 244 may lock trim panel 240 in place to prevent movement in up to six degrees-of-freedom. In addition, trim panel support brackets 244 may serve to define inlet gap 242.

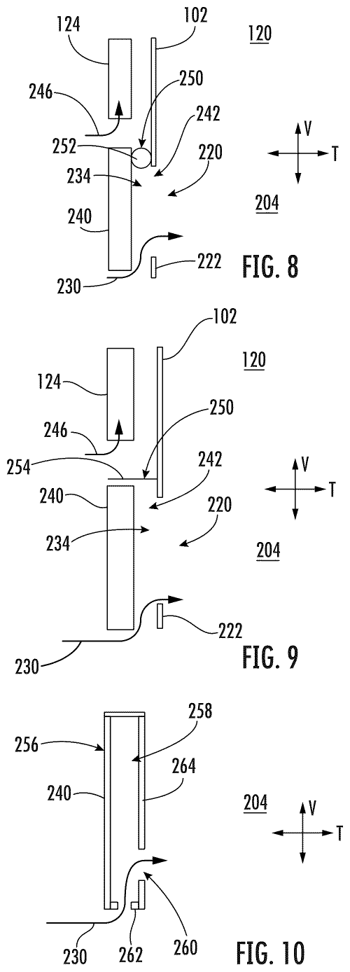

As noted above, the flow of cooling air 230 may generally pass around trim panel 240, through inlet gap 242, and into battery compartment 204. However, referring now specifically to FIGS. 8 and 9, a secondary flow of cooling air (referred to herein as door cooling air 246) may be desirable to cool door 124 during operation of cooking appliance 100. In this regard, the door cooling air 246 may flow through a bottom side of door 124 and be drawn upward to maintain a temperature of door 124 below a suitable threshold. However, drawing the flow of cooling air 230 through inlet gap 242 may conflict with the need for door cooling air 246. Accordingly, aspects of the present subject matter may be directed to features for balancing the need for cooling air in door 124 and battery compartment 204.

In this regard, for example, cooking appliance 100 may include a flow diverting element 250 for blocking the flow of cooling air 230 toward a top of trim panel 240. In general, flow diverting element 250 may be any feature(s) which balance the airflows to door 124 and battery compartment 204. For example, as shown in FIG. 8, flow diverting element 250 is a gasket 252 positioned within inlet gap 242 between trim panel 240 and access panel 224, e.g., at a top portion of front opening 220. In this manner, gasket 252 may seal a top portion of inlet gap 242 to prevent drawing in the door cooling air 246, and instead encouraging the flow of cooling air 230 to be drawn in through a bottom and/or sides of inlet gap 242. According to the example embodiment of FIG. 9, flow diverting element 250 may be a diversion baffle 254 positioned between door 124 and a top wall of trim panel 240. In this manner, diversion baffle 254 may divide the flow of cooling air 230 from the door cooling air 246, thereby ensuring that the cooling needs of door 124 and battery compartment 204 are both met.

According to still other example embodiments, such as that illustrated in FIG. 10, trim panel 240 may generally include a frame 256 defining an internal plenum 258 and/or one or more flow passageways 260 passing through frame 256 to permit the flow of cooling air 230 to pass into battery compartment 204. In this regard, for example, an example flow passageway 260 may pass through a bottom wall 262 of trim panel 240 and through a back wall 264 of trim panel 240. In this manner, the flow of cooling air 230 may be drawn from below trim panel 240, thereby providing sufficient separation from the door cooling air 246. In addition, such a construction would maintain an aesthetic appearance of trim panel 240, as the flow passageway 260 would not be visible to a user of cooking appliance 100. It should be appreciated that other trim panel 240 constructions and flow passageways 260 may be defined while remaining within the scope of the present subject matter. For example, trim panel 240 may also define one or more airflow apertures (e.g., similar to airflow apertures 232 of access panel 224) through which the flow of cooling air 230 may flow into battery compartment 204.

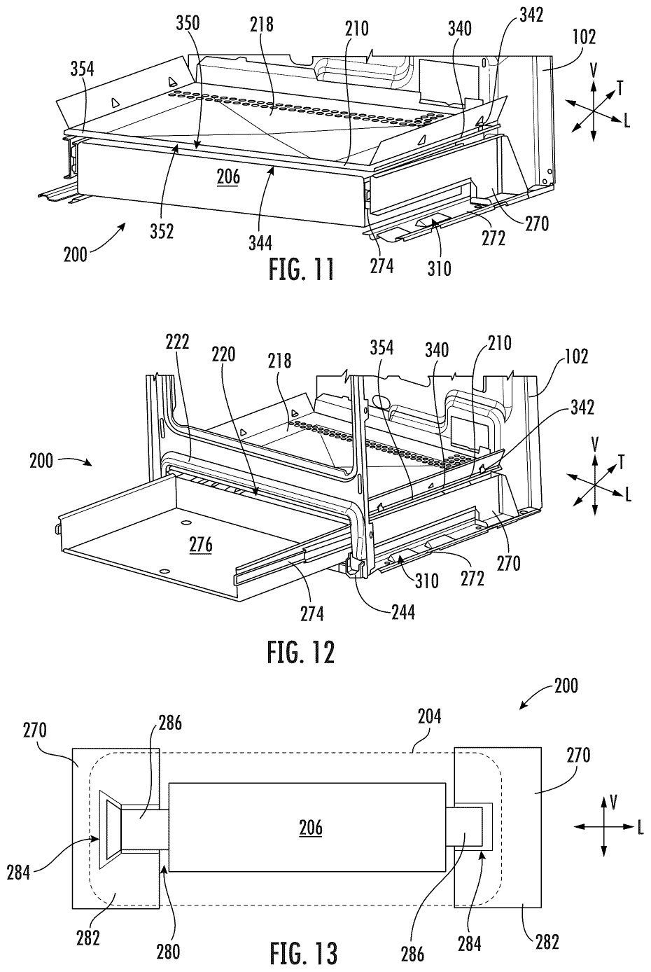

Referring now to FIGS. 11 through 13, battery 206 may generally be received and supported within battery compartment 204 in any suitable manner. For example, battery assembly 200 may include one or more battery support brackets 270 that support battery 206 within battery compartment 204. For example, battery support brackets 270 may be positioned on each lateral side of battery compartment 204 and may be rigidly attached to a base rail 272 of cabinet 102. In addition, for example, one or more slide bearings 274 may be attached to battery support brackets 270 such that battery 206 may be attached to slide bearings 274 and may slide into and out of battery compartment 204. According to still other example embodiments, as shown in FIG. 12, a moving shelf 276 may be attached to slide bearings 274 such that battery 206 may be placed directly on moving shelf 276.

According to an alternative embodiment, as shown for example in FIG. 13, battery assembly 200 may include a rail support system 280 that includes a fixed support structure 282 defining support grooves 284 that have a complementary geometry to mounting rails 286 that are defined by or attached to battery 206. In this manner, battery 206 may slide directly into battery compartment 204 along the transverse direction T by aligning mounting rails 286 and support grooves 284. It should be appreciated that other geometries and support configurations are possible and within the scope of the present subject matter. For example, support grooves may be defined in battery 206 and mounting rails may be defined by fixed support structure 282, the geometry of the complementary features may vary, the battery 206 may be supported from above or below, etc.

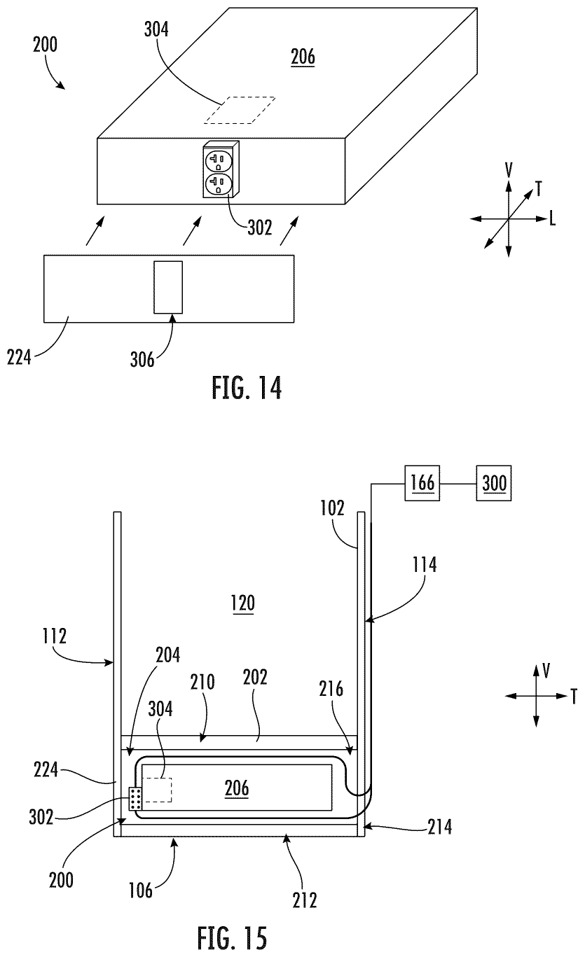

Referring now to FIGS. 14 and 15, electrical schematic views of cooking appliance 100 and battery assembly 200 will be described according to example embodiments of the present subject matter. As shown, cooking appliance 100 may include a main power connection to a main supply 300 of electrical power. According to example embodiments, main supply 300 may be mains electricity, e.g., provided by a utility provider to a conventional 120 VAC outlet within a user's residence. Battery 206 may be a battery supply or battery bank stored within battery compartment 204 of cooking appliance 100. In general, battery 206 may be a rechargeable battery of any suitable type or configuration. According to an example embodiment, main supply 300 may provide power at a first voltage (e.g., 120 VAC) and battery 206 may provide power at a second voltage (e.g., 230 VDC). It should be appreciated that these supply voltages may vary, and additional or alternative power sources may be incorporated into cooking appliance 100 while remaining within the scope of the present subject matter.

According to an example embodiment, battery 206 may be electrically coupled to main supply 300 in any suitable manner. For example, when a user or service technician installs battery 206, they may manually make connections to battery terminals or may utilize a plug to connect battery 206. According to alternative embodiments, battery 206 and battery housing 202 may include electrical contacts that automatically engage each other when battery 206 is properly installed. For example, when battery 206 is placed on moving shelf 276 and slid back into battery compartment 204, electrical contacts may automatically connect battery 206 to controller 166 and main supply 300. Once connected, controller 166 may generally be used to regulate the charging and/or discharging of battery 206. For example, battery 206 may be charged using main supply 300 at desirable times, e.g., when battery charge is low, energy usage is at an off-peak rate, heating elements are not being energized, etc.

It may be desirable to provide users with an extra source of power near cooking appliance 100, e.g., for powering devices other than cooking appliance 100. In this regard, as shown for example in FIG. 14, battery assembly 200 may include a power outlet 302 that is electrically coupled to battery 206 and is configured to receive an external power cord (not shown). Battery assembly 200 may further include a power electronics system 304 for converting DC power from battery 206 into AC power for supply at power outlet 302. For example, power electronics system 304 may include one or more inverters, rectifiers, voltage transformers, or other power electronics devices for converting power from AC to DC power (and vice versa), for adjusting voltage output, or for otherwise regulating or manipulating the flow of electricity as needed.

Notably, it may be desirable to facilitate user access to power outlet 302 without exposing them directly to battery 206, its terminals, or other wiring. Accordingly, access panel 224 defines an outlet aperture 306 for facilitating access to power outlet 302. In this regard, power outlet 302 may be received within outlet aperture 306, such that power outlet 302 may be accessed by removing trim panel 240. By contrast, according to an alternative embodiment, power outlet 302 may be mounted directly to access panel 224. According to such an embodiment, power outlet 302 may be wired directly to battery 206 when installing access panel 224.

Referring now generally to FIGS. 1 through 16, various airflow configurations that may be used to direct the flow of cooling air 230 will be described according to example embodiments of the present subject matter. As explained above, air intake 234 may be defined through inlet gap 242 and airflow apertures 232 defined in access panel 224. However, it should be appreciated that other air intake 234 locations are possible and within the scope of the present subject matter. For example, as illustrated in FIG. 7, air intake apertures 310 may be defined in base rail 272 of cabinet 102, such that the flow of cooling air 230 may be drawn in from lateral sides of cooking appliance 100. According to another example embodiment, an opening may be defined below base rail 272 to permit the flow of cooling air 230 into battery compartment 204 or the flow of cooling air 230 may pass between base rail 272 and battery support brackets 270. In addition, or alternatively, air intake apertures 310 may be defined in bottom panel 212 of battery housing 202. According to still other embodiments, it should be appreciated that the airflow paths may be reversed or directed in any other suitable manner.

According to an example embodiment, an exhaust aperture 312 may be defined by at least one of top panel 210, bottom panel 212, rear panel 214, or one of the two side panels 216. As illustrated, exhaust aperture 312 is defined in rear panel 214 of battery housing 202, e.g., such that the flow of cooling air 230 traverses the entire battery compartment 204 from front to back before being discharged. In addition, one or more diverter elements 314 may be positioned adjacent exhaust aperture 312 to direct the flow of cooling air 230 in the desired direction out of battery compartment.

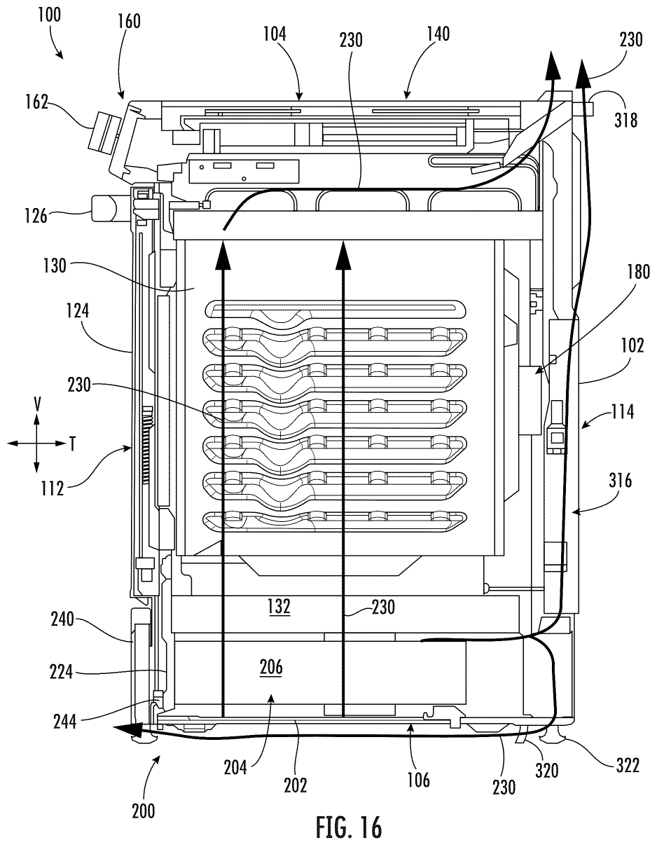

After exiting exhaust aperture 312, the flow of cooling air 230 may pass through a discharge path 316. For example, as shown in FIG. 16, discharge path 316 may be defined between one or more chamber walls 130 of cooking chamber 120 and cabinet 102, or between cabinet 102 and the enclosure. For example, discharge path 316 may be defined between a rear chamber wall 130 and a rear 114 of cabinet, between side chamber walls 130 and sides 108, 110 of cabinet, around the insulation retainer 218, between outer face of oven side insulation and cabinet, between outer face of oven back insulation and cabinet and/or enclosure, etc. According to still other embodiments, discharge path 316 may be defined underneath cooking appliance 100, e.g., between bottom 106 of cabinet 102 and the enclosure (e.g., the floor) upon which cooking appliance 100 is mounted. According to the illustrated embodiment, discharge path 316 may terminate at a discharge vent 318 or vent trim positioned proximate a top, rear of cabinet 102. Other flow configurations are possible and within the scope of the present subject matter.

Notably, particularly when discharge path 316 is directed upwards toward top 104 of cabinet 102, it may be desirable to prevent the flow of cooling air 230 from passing underneath cooking appliance 100. In this regard, if the flow of cooling air 230 exits underneath cooking appliance 100, the heated air may be entrained with the air passing through air intake 234. Accordingly, cooking appliance 100 may include a flow blocking element, such as a flexible flap 320 extending from a bottom panel 212 of battery compartment 204 downward along the vertical direction V. For example, flexible flap 320 may extend along an entire width of cabinet 102 along the lateral direction L to block the flow of cooling air 230, thereby redirecting it upward and out of cabinet 102. For example, flexible flap 320 may be at least as tall as a height of a support leg 322 of cooking appliance 100, such that it contacts the floor and fully blocks incoming airflow.

In general, the flow of cooling air 230 may be circulated in a passive manner or an active manner. For example, the flow of cooling air 230 may rely on buoyant flow of hot air, e.g., tending to enter cooking appliance 100 proximate bottom 106 of cabinet 102 and flow upward to top 104 of cabinet 102, e.g., being discharged through discharge vent 318. According to alternative embodiments, the flow may be actively circulating, e.g., using a fan, blower, or other suitable air circulation or regulating device.

According to the embodiment illustrated in FIGS. 5, 6, and 16, cooking appliance 100 may include a fan 330 that is fluidly coupled to battery compartment 204 for urging the flow of cooling air 230. In general, fan 330 may be any suitable type of fan, e.g., such as an axial fan, a radial fan, or a tangential fan. In addition, fan 330 may be positioned, oriented, and configured as desired to effectively urge the flow of cooling air 230. For example, fan 330 may be positioned within battery compartment 204, e.g., proximate to or mounted to rear panel 214 of battery housing 202 and may be fluidly coupled to exhaust aperture 312. Other locations are possible and within the scope of the present subject matter.

Notably, heat transfer from cooking chamber 120 into battery compartment 204 may result in undesirable heating of battery compartment and inefficient operation of battery 206 and low effectiveness of the flow of cooling air 230. Accordingly, cooking appliance 100 may include a heat shield 340 that is positioned between cooking chamber 120 and battery compartment 204 to prevent such undesirable heat transfer. For example, heat shield 340 may generally extend along an entire width and depth of battery compartment 202 or cooking chamber 120 and may define a top wall (e.g., top panel 210) of battery housing 202.

For example, heat shield 340 may be positioned below insulation retainer 218 along the vertical direction V. In this regard, heat shield 340 may be mounted directly to cabinet 102 or battery housing 202. Alternatively, heat shield 340 may be suspended from insulation retainer 218 using one or more mechanical fasteners or brackets 342. In order to prevent conductive heat transfer through heat shield 340, an air gap 344 may be defined between insulation retainer 218 and heat shield 340 and/or between battery 206 and heat shield 340. In this manner, the flow of cooling air 230 may pass between battery 206 and heat shield 340 to prevent conductive heat transfer.

In addition, in order to prevent radiant heat transfer from cooking chamber 120, heat shield 340 may have a top face 350 that has a first emissivity and a bottom face 352 that has a second emissivity According to example embodiments, the first emissivity may be lower than the second emissivity, e.g., such that radiant heat from cooking chamber 120 is redirected upward while radiant heat from battery 206 may also be directed upward and away from battery compartment 204. For example, the first emissivity may be between about 0.01 and 0.5, between about 0.05 and 0.4, between about 0.1 and 0.3, or about 0.2. For example, the second emissivity may be between about 0.6 and 1, between about 0.8 and 0.95, or about 0.9.

The differing emissivity of top face 350 and bottom face 352 of heat shield 340 may be achieved in various manners. For example, heat shield 340 may include a top layer and a bottom layer that are joined together. For example, the top layer may be aluminum foil or polished aluminum, and the bottom layer may be painted steel. By contrast, heat shield 340 may be a single layer having top face 350 and bottom face 352. According to such an embodiment, one or more coatings 354 may be applied to one or more of top face 350 and bottom face 352. For example, heat shield 340 may have a nickel-electroplate coating on top face 350 and a paint coating on bottom face 352. Other coatings and layers are possible and within the scope of the present subject matter.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance defining a vertical direction, a lateral direction, and a transverse direction, the cooking appliance comprising:
a cabinet;
a cooking chamber positioned within the cabinet;
an electric heating element positioned in thermal communication with the cooking chamber;
a battery housing positioned within the cabinet adjacent to the cooking chamber, the battery housing defining a battery compartment and a front opening for accessing the battery compartment;
a battery mounted within the battery compartment and being electrically coupled to the electric heating element;
an access panel removably positioned over the front opening for providing selective access to the battery compartment; and
one or more airflow apertures defined in the access panel or along a portion of a perimeter of the access panel through which a flow of cooling air may flow into the battery compartment.

2. The cooking appliance of claim 1, further comprising:
a trim panel attached to a front of the access panel, wherein an inlet gap is defined between the trim panel and the access panel through which the flow of cooling air may flow into the battery compartment.

3. The cooking appliance of claim 2, wherein the trim panel comprises a frame defining one or more flow passageways passing through the frame to permit the flow of cooling air to pass into the battery compartment.

4. The cooking appliance of claim 3, wherein the one or more flow passageways pass through a bottom wall of the frame of the trim panel.

5. The cooking appliance of claim 3, wherein the one or more flow passageways pass through a back wall of the trim panel.

6. The cooking appliance of claim 2, further comprising:
a flow diverting element for blocking the flow of cooling air in proximity to the trim panel.

7. The cooking appliance of claim 6, wherein the flow diverting element is a gasket positioned within the inlet gap between the trim panel and the access panel or the cabinet.

8. The cooking appliance of claim 6, wherein the flow diverting element is a diversion baffle positioned between a door of the cooking appliance and a top wall of the trim panel.

9. The cooking appliance of claim 2, wherein the trim panel defines one or more airflow apertures through which a flow of cooling air flows into the battery compartment.

10. The cooking appliance of claim 1, wherein the cabinet comprises a base rail and an opening is defined below, through, or around the base rail to permit the flow of cooling air into the battery compartment.

11. The cooking appliance of claim 10, further comprising:
a battery support bracket, wherein the flow of cooling air passes between the base rail and the battery support bracket, around a side of the battery compartment, or through an aperture in the side of the battery compartment.

12. The cooking appliance of claim 1, wherein the battery compartment is positioned below the cooking chamber along the vertical direction.

13. The cooking appliance of claim 1, further comprising:
a main power connection to a main supply of electrical power.

14. A battery assembly for a cooking appliance, the cooking appliance comprising an electric heating element, the battery assembly comprising:
a battery housing defining a battery compartment and a front opening for accessing the battery compartment;
a battery mounted within the battery compartment and being electrically coupled to the electric heating element;
an access panel removably positioned over the front opening for providing selective access to the battery compartment; and
one or more airflow apertures defined in the access panel or along a portion of a perimeter of the access panel through which a flow of cooling air may flow into the battery compartment.

15. The battery assembly of claim 14, further comprising:
a trim panel attached to a front of the access panel, wherein an inlet gap is defined between the trim panel and the access panel through which the flow of cooling air may flow into the battery compartment.

16. The battery assembly of claim 15, wherein the trim panel comprises a frame defining one or more flow passageways passing through the frame to permit the flow of cooling air to pass into the battery compartment.

17. The battery assembly of claim 16, wherein the one or more flow passageways pass through a bottom wall of the frame of the trim panel.

18. The battery assembly of claim 16, wherein the one or more flow passageways pass through a back wall of the trim panel.

19. The battery assembly of claim 15, further comprising:
a flow diverting element for blocking the flow of cooling air in proximity to a top of the trim panel.

20. The battery assembly of claim 19, wherein the flow diverting element is a gasket positioned within the inlet gap between the trim panel and the access panel or the cabinet.
